(19) United States
(12) Patent Application Publication
(10) Pub. No.: US 2009/0040516 A1
(43) Pub. Date: Feb. 12, 2009

(54) SPECTROSCOPIC SYSTEM

(75) Inventors: Bernard S. Fritz, Eagan, MN (US); Paul E. Bauhahn, Fridley, MN (US); James A. Cox, New Brighton, MN (US); Brian C. Krafthefer, Stillwater, MN (US); Tzu-Yu Wang, Maple Grove, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/837,359

(22) Filed: Aug. 10, 2007

(51) Int. Cl. G01J 3/44; G01J 3/28

(52) U.S. Cl. 356/301; 356/328; 356/330

(57) ABSTRACT

A spectroscopic system having a coded aperture as a gating device. Light of a Raman scattering may enter the system and encounter a mask gate. The mask may have a matrix of micro mirrors some of which pass light on to a diffraction grating when the gate is on. Some of the mirrors will not pass on light thereby resulting in coded light to the grating. If the gate is off, then no light is passed on to the grating. The grating may pass the coded and spectrally spread light on to a detector array. The array signals representing the light on the array may go to a processor so one can obtain information about the target that emanated the Raman scatter when impinged by a light beam.

### BACKGROUND

The invention pertains to spectroscopy and particularly to spectroscopy of scattered light.

### SUMMARY

The invention is a stand-off coded aperture spectrometer with mask gating.

### BRIEF DESCRIPTION OF THE DRAWING

FIG. 1 is a diagram of a spectrometer system having a coded aperture gate;

FIG. 2 is a diagram of a coded mask for the gate of the spectrometer system;

FIG. 3 is a diagram of a portion of a micromirror array;

FIG. 4 is a diagram of an example micromirror used in the mask gate;

FIG. 5 is a diagram of the elements for a one-dimensional arrangement for the spectrometer system;

FIG. 6 is a diagram of matrices relating to the one-dimension arrangement of FIG. 5; and

FIG. 7 is a diagram of spectra, a mask code and a detector array image of a two-dimensional arrangement for the spectrometer system.

### DESCRIPTION

To lead into a background of the present system, it may be noted that when light is scattered from an atom or molecule, most photons are elastically scattered (i.e., Rayleigh scattering). The scattered photons may have the same frequency as the incident photons. However, a small fraction of light (e.g., about 1 in 10⁷ photons) may be scattered at frequencies different from the frequency of the incident photons. This may be a result of inelastic scattering. Such scattered light may provide information about the molecules' vibrational quantum states. Although Raman scattering may occur with a charge in vibrational, rotational or electronic energy of a molecule; a primary concern is the vibrational Raman effect.

There may be several kinds of Raman scattering. If a molecule absorbs energy (i.e., the resulting photon has lower energy), then one has Stokes scattering. If the molecule loses energy (i.e., the resulting photon has higher energy), then one has anti-Stokes scattering. The Stokes spectrum may be more intense than the anti-Stokes spectrum since a Boltzmann distribution may indicate that more molecules occupy lower energy levels than the higher levels in most cases. An absolute value should not depend on Stokes or anti-Stokes scattering. In many instances of scattering, the vibrational energy levels may represent a unique signature or footprint such that the material or substance may be identified. The intensities of the Raman bonds may be dependent just on a number of molecules occupying different vibrational states, when the scattering process occurs.

Stand-off Raman spectroscopy for detection of remote chemical or biological agents may involve low level spectral signal measurements done in a potentially high ambient background environment (i.e., daytime). A requirement for such a spectrometer may include a large etendue (i.e., light-grasping ability) along with a pulsed-light source gated-receiver pair. This may permit an improved signal-to-background ratio by a collection of as much signal possible along with a reduction in background signal by implementing a pulsed-laser source with detector gating such that the signal collection only occurs when the actual signal is present. Gating of a high etendue spectrometer might be a requirement for making such a measurement.

Gating of a high entendue spectrometer such as one based on a coded aperture and a CCD array detector may present issues. Gating of CCD arrays may often be accomplished by using an image intensifier where the gating actually occurs. This may limit the selection of potential detector arrays along with a low quantum efficiency (i.e., <10%) for wavelengths of 900 nm or greater which would be required for Raman illumination lasers of about 800 nm. If a coded mask of the spectrometer is constructed as a spatial light modulator (SLM), this would allow one to easily gate the receiver while also performing an encoding function.

Some systems may be a single detector Hadamard spectrometer requiring a reconfigurable coding mask. This approach would require multiple configurations of the mask to make a single measurement, thus not permitting gating of the receiver as an option for a single spectra measurement. For such system to make an “N” number of resolution element spectra measurements, it may require an “N” number of different mask encodements. The coding mask is typically positioned before the dispersing element of the spectrometer where the radiation is spatially separated in wavelength.

A spatial light modulator which may be used as a coded mask/gating element is a Texas Instruments digital micromirror device (DMD). The DMD may have 1024×768 individually addressable mirror-pixels or micromirrors. The micromirrors may be used as shutters to either pass incident light on to the detector or redirect the light to a light dump. The micromirrors may accomplish this by toggling between two angular positions. The toggling or switching may have a speed of about 15 micro seconds. In this application, all of the micromirrors may be normally positioned to the off position. However, when a Raman illumination source is pulsed, then a subset of the micromirrors which define the required encoding may be toggled to the on position during the Raman illumination pulse.

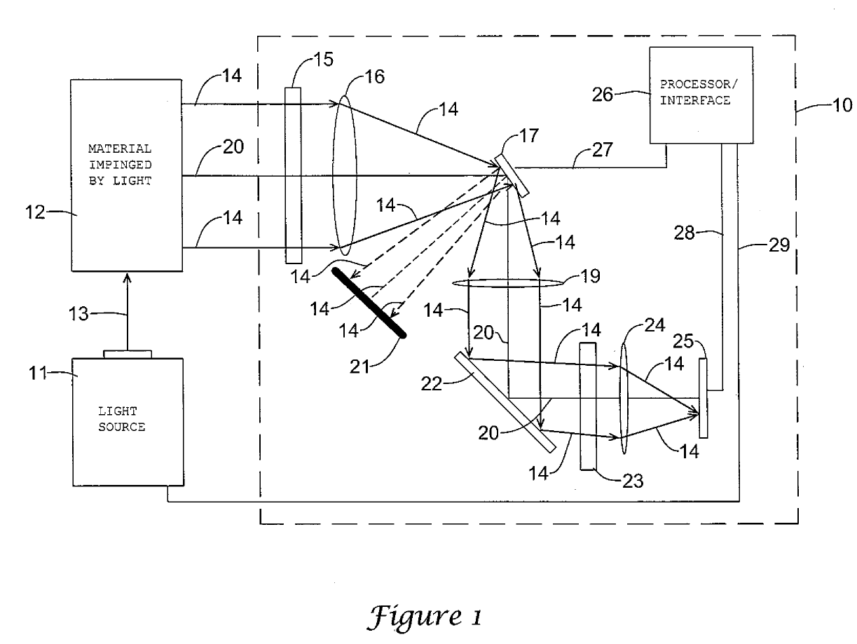

FIG. 1 is a diagram of a stand-off coded aperture spectrometer system 10. It may detect Raman scattered light in daylight. The system may have mask gating. A light source 11 may impinge a sample material 12 with light 13. An illustrative example of light 13 may be a 785 nm laser beam. Other kinds of light sources may be implemented. Material 12 may scatter light 13 into other light 14. Light 14 may be light of Raman scattering. Raman scattered light 14 may enter system 10 through a filter 15. The filter may block out light from the illuminator or source 11. For instance, filter 15 may block light having wavelengths shorter than those of the Raman scattered light 14. The Raman scattered light relative to the example source light 13 may have wavelengths ranging from about 800 to 1000 nm. Light 14 may proceed from filter 15 onto a fore optic 16. Fore optic 16 may be one or more lenses that focus light 14 onto a mask gate 17.

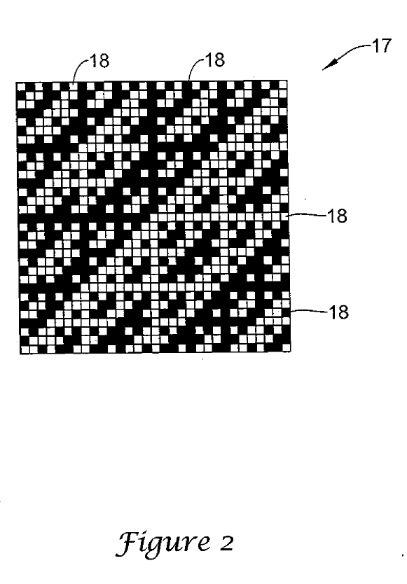

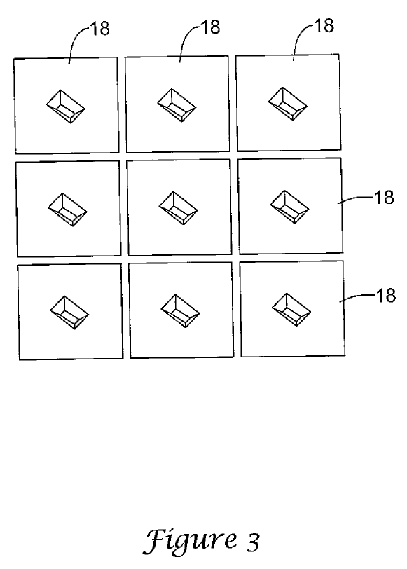

Mask gate 17 may be regarded as a coded aperture. The mask may be a two-dimensional array of reflective and non-reflective spots, which may represent ones and zeros, respectively. Various patterns of ones and zeros may represent different codes and effective throughputs. FIG. 2 is an example of a mask 17 having a coded array. The white spots may represent ones and the dark spots may represent zeros. The mask 17 may be an array of mirrors 18 as shown by a portion of an array of mask 17 in FIG. 3. Each mirror 18 may have two positions which may be regarded as an “on” position and an “off” position. When a mirror 18 of mask 17 is in an “on” position, mirror 18 is tilted so that it can reflect the light 14 through a collimating lens or lenses 19 onto a diffractive grating 22. When a mirror 18 is an “off” position, mirror 18 is tilted in another position so that it cannot reflect light 14 through the collimating lens or lenses 19 onto the diffractive grating 22. Instead, mirror 18 can reflect light 14 to a light dump 21 when in an “off” position. Light 14 may be dissipated by dump 21.

If the mask gate 17 is off, then all of the mirrors 18 in the array of the mask should be in the off position and therefore all of light 14 would be reflected to dump 21, with no light going to the grating 22 via the lens 19. On the other hand, if the mask gate 17 is on, then some of the mirrors 18 may be in the on position thereby reflecting some of the light 14 through lens 19 to grating 22. In effecting an encoded pattern in mask 17 as a coded aperture, some of the mirrors 18 may be in the off position thereby reflecting some of the light to the light dump 21. The convolved light 14 from the mask gate 17 when on may go to grating 22 via the lens. Grating 22 may disperse light 14 according to wavelength.

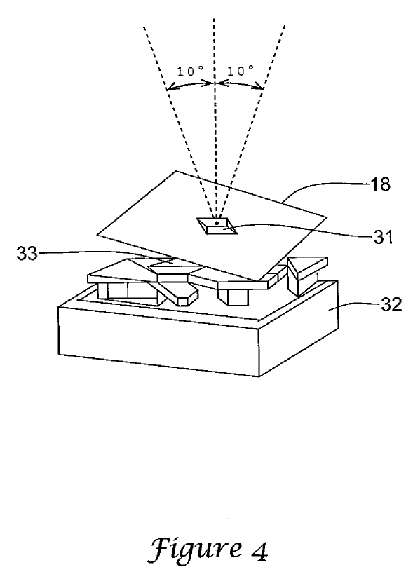

FIG. 4 shows an example mirror 18 that may swiveled between an “on” and an “off” position. Mirror 18 may be situated on a pivot 31 centered on a base 32. Mirror 18 may have a normally “off” position as maintained by a tension hinge 33. However, an electrical signal may be applied to tilt mirror 18 into an on position. One mechanism may be an electrostatic one which may pull the mirror into the on position. Once power is disconnected, the mirror 18 may return to its off position. Mirror 18 may tilt in increments of 10 degrees in certain designs and increments of other magnitudes for other designs.

Signals to mask 17 from a processor/interface 26 may turn on the mask gate 17 according to a preferred pattern of “on” and “off” mirrors in the array. Also the timing of when mask 17 should be on or off may be provided by processor/interface 26 via connection 27. This timing via the connection may be influenced by a signal to or from light source 11 via a connection 29.

An example mechanism to be use as the mask gate 17 may be a digital micromirror device (DMD™) by Texas Instruments Inc. This device may be a 768×1024 micromirror array. The mask or matrix of the DMD may have a 2 mm side dimension. Compared to a 50 micron slit, much more energy may be conveyed by mask 17 even if one-half of the mirrors are in an off position. It may work with wavelengths of light between 600 um and 2.5 microns. A code that may be implemented in the array for the present system 10 can have a masking pattern of a cyclic Hadamard S-matrix. The speed of this device may be about 15 microseconds. Speeds of other similar devices may be much faster. The time that mask gate 17 is on may be about the same amount of time as the laser pulse duration from light source 11 and as that of the Raman scattered light 14.

Light 14 in an encoded pattern from mask gate 17 via collimating lens 19 may impinge the grating 22 which diffracts the light 14 spectrally, and eventually impinges a CCD detector array 25. Light 14 may reach array 25 via a filter 23 and a focusing lens 24. An optical path of system 10 may be indicated generally by optical axes 20. Filter 23 may pass light having wavelengths about the same or shorter than the wavelengths of the Raman scattered light. This filter may reduce the effects of fluorescence. Signals of the light 14 on the CCD array 25 may go to the processor/interface 26 via a connection 28 to be deconvolved.

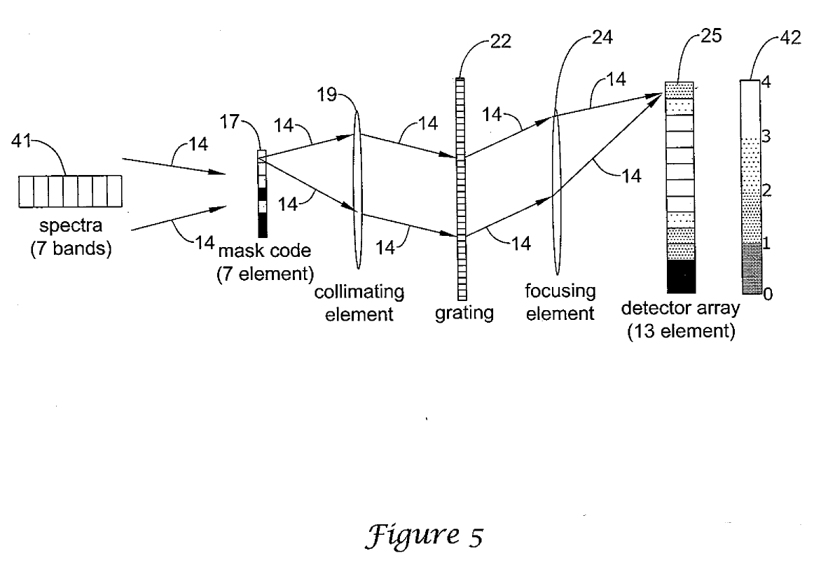

FIG. 5 is a diagram of a coded aperture spectrometer (with a one-dimensional detector array), having the light 14, as a one-dimensional code example, going through the stages from mask gate 17 code to detector array 25. The seven band spectra 41 of light 14 may go through a (7 element) mask 17 code, collimating element 19, grating 22, focusing element 24 and a 13 element detector array 25. A gray or color scale 42 may be used to measure or read the image on array 25.

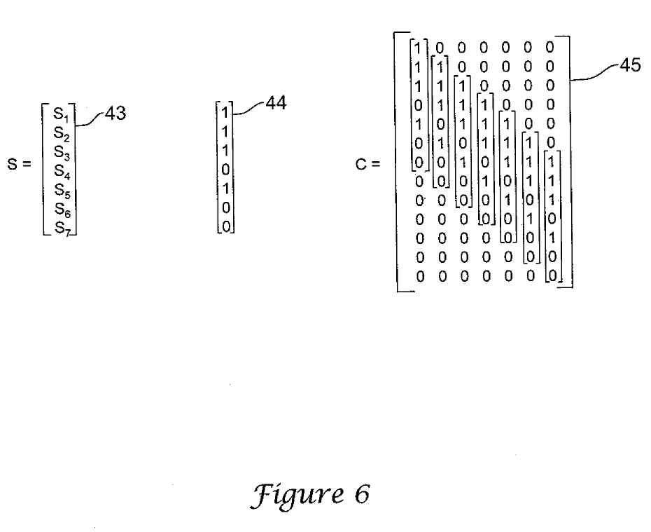

FIG. 6 shows a spectra matrix (S) 43 form and the 7 element mask code matrix 44. One may note in system 10 a convolving of spectra by the mask 17 code onto the detector array 25. A permutation of the mask gate 17 code may used to form a linear set of equations representing a data vector on the detecting array 25, where D=C×S. C is matrix 45 shown in FIG. 6 where the rows are of the detector bin and the columns are wavelength bins. One may use a least squares fit to determine S (spectra) from D (detector data). One may note Sᵣ=C/D—reconstructed spectra (Matlab™ least squares fit), and Sᵣ=Isqnormeg (C,D) (Matlab™ nonnegative least squares fit).

The following reveals a basic Matlab™ script which may be used in modeling a coded aperture spectrometer like system 10.

```
%input spectra
I;
%detector noise (Gaussian) signal independent
noise=randn(ndet,1);
%determine resultant detector signal from input
    specta +noise
D=C*I+noise;
%reconstructed spectra from detector signal
%nonnegative least squares fit method
Ir=lsqnonneg(C,D);
%least squares fit method
%Ir=C\D;
%rms input spectra − reconstructed spectra
rms=norm(I−Ir)/sqrt(length(I))
%Signal-to-Noise (used with multiple statistical
    trials)
Sn=mean(Ir)/std(Ir)
```

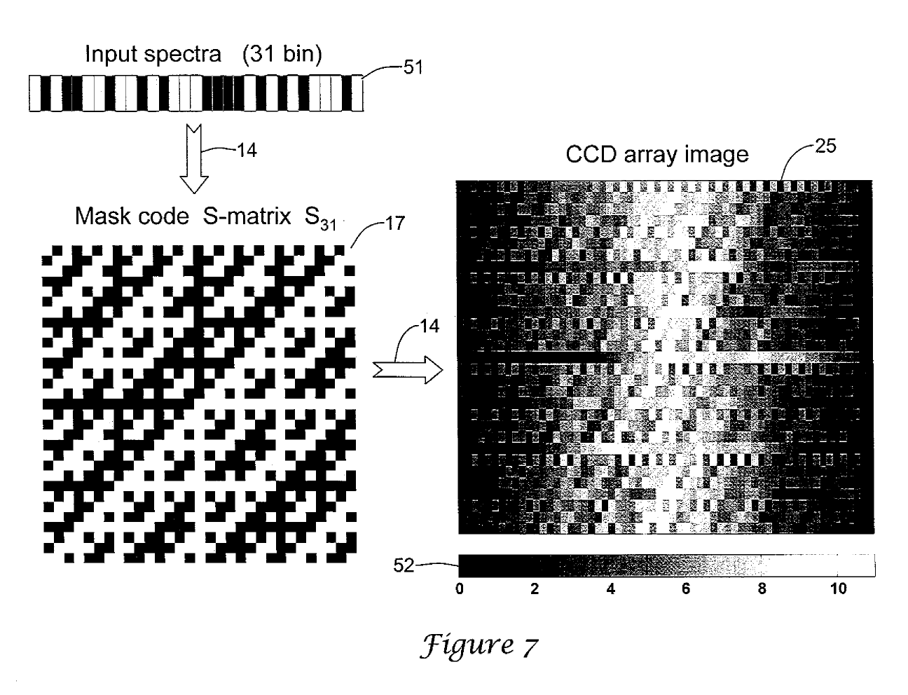

FIG. 7 shows a two-dimensional coded aperture spectrometer example. There may be an input spectra 51 of 31 bins of light 14 going to a mask gate 17 code S-matrix S₃₁. The light 14 may eventually go from mask gate 17 to CCD array 25 which shows an image of the light 14 after going through collimating lens 19, diffraction grating 22 and focusing lens 24. Also shown is a gray or color scale 52 which may be used to measure or read the image on array 25. Some factors of the coded aperture or mask gate 17 in lieu of a slit may include a reduction of noise at spectral peaks, background noise increased for Poisson signal dependent noise, and a redistribution of noise.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A spectrometer system comprising:
a light gate;
an optical grating proximate to the light gate; and
a detector array proximate to the grating.

2. The system of claim 1, wherein the light gate comprises:
an array of mirrors; and
wherein:
at least some of the mirrors of the array have an on position and an off position;
a mirror in an on position can reflect incoming light to the grating; and
a mirror in an off position cannot reflect incoming light to the grating.

3. The system of claim 2, wherein the array of mirrors is a reflective mask to incoming light.

4. The system of claim 3, wherein the reflective mask has an encoding pattern when at least some of the mirrors are in an on position.

5. The system of claim 4, wherein the pattern has a form of a Hadamard S-matrix.

6. The system of claim 4, wherein the pattern is a 2-dimensional pattern.

7. The system of claim 6, wherein:
the light gate is for passing certain light to the grating and blocking other light from the grating; and
the certain light is light scattered from a sample by a light source.

8. The system of claim 1, wherein:
the light gate is for passing certain light to the grating and blocking other light from the grating; and
the certain light is Ram an scattered light.

9. The system of claim 8, further comprising:
a filter for blocking light having a wavelength shorter than a wavelength of the certain light, from the light gate; and
a filter for blocking light having a wavelength longer than the certain light, from the detector array.

10. The system of claim 7, wherein:
the light gate is a coded aperture; and
the light received by the detector array is decoded for obtaining spectral information about the certain light.

11. The system of claim 10, wherein the coded aperture is a digital micromirror device.

12. A spectrometric analyzer comprising:
a gating device;
a diffraction device proximate to the gating device; and
a detector array proximate to the diffraction device; and
wherein the gating device is a coded aperture.

13. The analyzer of claim 12, wherein the coded aperture is a digital micromirror device.

14. The analyzer of claim 12, wherein:
the coded aperture has a mask;
the mask has a plurality of pixels;
each pixel a first position and a second position;
the first position conveys light received by the pixel to the diffraction device;
the second position prevents light received by the pixel from going to the diffraction device;
when the gating device is on, the mask is encoded with some pixels in a first position and some pixels, if any, in a second position; and
when the gating device is off, the mask should have no pixels in the first position.

15. The analyzer of claim 14, wherein the mask is encoded with a Hadamard S-matrix.

16. The analyzer of claim 15, wherein:
the gating device is on upon receipt of Raman scattered light; and
the gating device is off when not in receipt of Raman scattered light.

17. The analyzer of claim 16, further comprising:
a first filter for light going to the gating device; and
a second filter for light going from the diffraction device to the detector array; and
wherein:
the first filter is for passing light only having a wavelength about the same or longer than the wavelength of Raman scattering; and
the second filter is for passing light only having a wavelength about the same or shorter than the wavelength of the Raman scattering.

18. A method for spectroscopy comprising:
receiving scattered light;
focusing the light on a coded aperture gate;
opening the gate for light that is Raman scattered light from a sample impinged by light from a light source;
closing the gate as soon as the Raman scattered light is no longer received; and
letting the light be directed by the open gate to a diffractive device to be diffracted according to wavelength on a detector array.

19. The method of claim 18, wherein:
the coded aperture gate is an array of a plurality of mirrors;
each mirror can swivel between a first position and a second position;
in the first position, a mirror reflects impinging light to the diffractive device;
in the second position, a mirror reflects impinging light to a light dump;
for an open gate, each mirror is in either open position or a closed position; and
for a closed gate each mirror is in a closed position.

20. The method of claim 19, wherein when the gate is open, the light is reflected as encoded light according to the mirrors' positions.
